(19) United States
(12) Patent Application Publication
(10) Pub. No.: US 2010/0236114 A1
(43) Pub. Date: Sep. 23, 2010

(54) Illuminated display assembly

(76) Inventor: Larry N. Shew, White Lake, MI (US)

Correspondence Address: L.C. Begin & Associates, PLLC, 510 Highland Avenue, PMB 403, Milford, MI, 48381, US

(21) Appl. No.: 12/381,788

(22) Filed: Mar. 17, 2009

(51) Int. Cl. G09F 13/04; G09F 13/14

(52) U.S. Cl. 40/564

(57) ABSTRACT

An illumination display assembly 10 is provided whereby centrally received lighting cove assemblies 22 are removably fixed or adjustably positioned to provide customized lighting across central portions of the assembly 10. Receivers or receiver groups 24, for example, may be employed to removably fix lighting cove assemblies 22 within a central portion of the assembly 10, thereby facilitating the modification and customization of both the advertising and the lighting as desired.

### BACKGROUND OF THE INVENTION

The present invention relates to illuminated displays that convey information that is represented on a translucent or transparent panel. It is an ongoing challenge to provide customized lighting to improve the efficacy of the advertising panel, and to also improve on the aesthetic appeal of the background lighting typically included in these displays.

Oftentimes, fluorescent or other types of light bulbs have been fixed in back or recessed panels to illuminate a front panel on a typical display assembly. In this way, the need to provide exterior lighting for the display is obviated. However, when interior lighting is provided in an illuminated display assembly, certain challenges are presented. The presence of “hot spots” for example, due to the light intensity being greater in the immediate periphery of the inner light bulb or source, is evident as the light is transmitted through the upper or front panel. As a result, one or more “hot spots” are apparent when viewing the display as presented to passers-by.

Additionally, because of the greater intensity of the lighting immediately around the light source, it has been a challenge to provide uniform lighting. Reflective configurations or sub-assemblies have been employed to diffuse the lighting, thereby mitigating the intensity of the lighting about the immediate periphery of the light source or bulb. However, providing uniform lighting, or providing desired customized lighting about a certain region of the display becomes more challenging as the light is dispersed over greater areas, in a relatively larger display for example. Furthermore, as the thickness of the display unit is reduced, whereby the cavity existing between the front and back panels of a typical display is reduced, the more difficult it is to provide uniform lighting or evenly dispersed lighting across various regions of the display assembly.

Yet another challenge is the ability to provide relatively greater lighting effects while yet providing a reduction in the total power used as compared to known lighting displays. In general, known lighting displays utilized lighting about the periphery of the assembly, but in many instances do not utilized lighting in the middle or central areas of the display. As a result, greater power must be used to transmit light across the central region of the lighting display. Even then, with relatively larger signs the light intensity dissipates as it travels inwardly from its peripheral source, whereby the centralized region of the display simply does not exhibit the same relative uniform lighting or brightness as the peripheral edges of the lighting display.

Yet another challenge is the ability to customize or direct lighting in the display without the creation of hot spots. Stated another way, it is desirable to perhaps emphasize or increase the relative lighting in a certain region or portion of the display without creating “hot spots” or relatively bright areas that detract from the aesthetic appearance of the display. Furthermore, it may be desirable to “re-customize” or alter the customized lighting as the respective display is desirably changed.

Certain lighting sources have been created that address some of the concerns described. However, these options are often relatively expensive. Fiber-optic lighting exemplifies one choice that addresses certain of these concerns, but in certain circumstances may be deemed to be cost-prohibitive.

Accordingly, it would be an improvement in the art to provide an illuminated display assembly that inherently resolves one or more of these concerns.

### SUMMARY OF THE INVENTION

An illuminated display assembly is provided that contains a front panel and a back panel, wherein the front panel is removably attached to the back panel. The front panel is made from a translucent or transparent material such as glass, plastic, or polymeric medium. Snap fit assemblies or other fixtures are provided across the back panel to accommodate the custom orientation of a light assembly therein. A light assembly provides light in a region existing between the two panels. Snap fit assemblies or other light assembly fixture means are provided across the back panel to accommodate the custom orientation of one or more light assemblies therein. In accordance with the present invention, the lighting assembly is snap fit or otherwise adjustably positioned on the back panel and provided in such a way as to provide substantially uniform lighting across the interior of the display, or, to provide uniform lighting in a desired region or regions in the interior of the display. One or more light emitting diode (LED) lighting sub-assemblies are removably fixed on the back panel to provide lighting customized to the particular display being illuminated. One or more coves are provided, wherein each of the one or more coves corresponds to one of the lighting sub-assemblies and are integral to each sub-assembly thereby covering the lighting to prevent “hot spot” formation. Each cove is also provided with a reflective inner surface thereby providing dispersion of the LED lighting from beneath each cove. The net effect is to provide uniform lighting across the display assembly, or to provide uniform lighting in desired regions of the display panel whereby uniform or customized lighting is assured regardless of the size of the display assembly.

### BRIEF DESCRIPTION OF THE DRAWINGS

FIG. 1 is a perspective view of a first embodiment of the present invention.

FIG. 2 is a plan view of a second embodiment of the present invention.

FIG. 3 is a cross-sectional view taken along line A-A of the second embodiment of the present invention.

FIG. 4 is a side view of the back panel and front panel interface of one embodiment in accordance with the present invention.

FIG. 5 is a perspective view illustrating attachment of yet another embodiment of an illumination display assembly onto a substrate such as a vehicle.

FIG. 6 is a perspective view of a cove lighting assembly of the present invention.

FIG. 7 is a plan view of a cove lighting assembly of the present invention.

FIG. 8 is a side view of a third embodiment of the present invention.

FIG. 9 is a top view of a lighting display as known in the art, illustrating the need for relatively greater lighting for an area equivalent to the area of an embodiment of the present invention as shown in FIG. 10.

FIG. 10 is a top view of a lighting display in accordance with the present invention, illustrating relatively less lighting for an area equivalent to the area shown in FIG. 9.

FIG. 11 illustrates dissipation of the light within the central portion of a lighting assembly when only using peripheral lighting and a flat back panel as shown in FIG. 9.

FIG. 12 illustrates a relative uniform light distribution across the central portion of a lighting assembly as shown in FIG. 10.

FIG. 13 illustrates contact points on a cove lighting assembly made in accordance with the present invention.

FIG. 14 illustrates communication between the contact points on the cove lighting assembly and the power supply strip, in accordance with one aspect of the invention.

FIG. 15 illustrates a side view of a lighting strip as it communicates with the interior side of the back panel of the display assembly, in accordance with the present invention.

FIG. 16 illustrates a top view of a lighting strip, in accordance with the present invention.

FIG. 17 illustrates a perspective view of a lighting strip, in accordance with the present invention.

FIG. 18 illustrates yet another embodiment in accordance with the present invention. The interior side of the back panel contains one or more slanted or pitched surfaces.

FIG. 19 illustrates yet another embodiment in accordance with the present invention. The interior side of the back panel contains one or more slanted or pitched surfaces. The display assembly shown contains peripheral and centrally positioned cove lighting assemblies, and further illustrates the relative light intensity across the central area of the light assembly.

FIG. 20 is an exploded view of the embodiment of FIG. 19, further illustrating the peripheral and centrally positioned cove lighting when combined with at least one slanted surface on the interior side of the back panel.

FIG. 21 illustrates yet another method of adjustably positioning the lighting assemblies within an attachment means fixed to or formed in the back panel.

### DETAILED DESCRIPTION

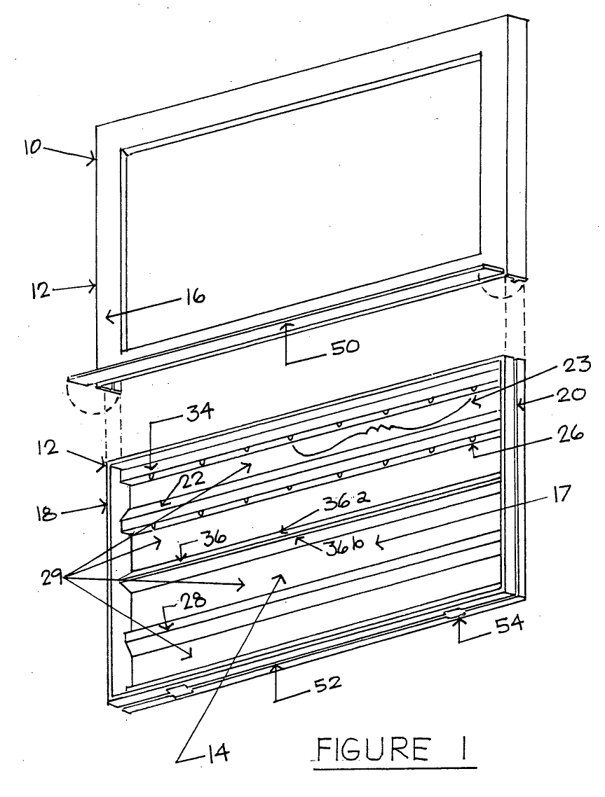

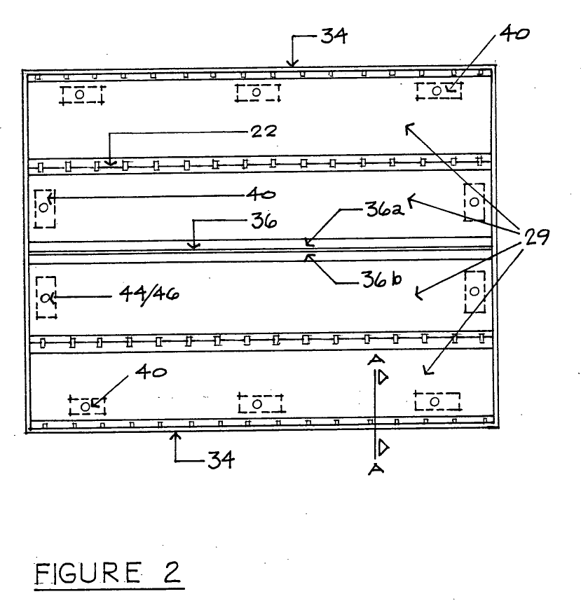

As shown in FIG. 1, a first embodiment of an illumination display assembly 10 includes a housing 12 for containment of the constituents of the assembly 10. A back panel 14, forming a rearward surface of the housing 12, provides a mounting surface for attachment of the various constituents of the assembly 10, wherein the back panel 14 contains an interior side 14a and an exterior side 14b. If desired, the back panel 14 may be covered or formed with a reflective material, such as a white, foiled, or generally glossy or shiny surface, to reflect light throughout the assembly 10 and out a front panel 16 described below. A front panel 16, forming a frontward surface of the housing 12 and made from a translucent or transparent material such as plastic or glass, provides a mounting surface for an advertising medium. In yet another embodiment, the panel 16 may be a translucent advertisement sized to interface with the back panel 14, as schematically shown in FIG. 4, for example. Accordingly, a translucent polymeric display panel may if desired constitute the front panel 16. Or, in yet another example, a translucent cellulosic or paper material may constitute the front panel 16 whereby light is transmitted therethrough when generated within the interior 17 of assembly 10.

Referring again to FIG. 1, in one embodiment, a first sliding track 18 and a second sliding track 20 are provided as side portions to back panel 14, thereby facilitating sliding engagement of front panel 16 along sliding tracks 18 and 20. Stated another way, back panel 14 slidably communicates with front panel 16 by virtue of sliding tracks 18 and 20. One or more lighting cove assemblies 22 extend across the central area of the back panel 14 and are removably fixed thereto. Stated another way, each lighting cove assembly 22 may be adjustably positioned on the interior surface 14a. One or more receivers or attachment means 24, and preferably two or more attachment means 24, are fixed onto back panel 14 for receipt of a corresponding lighting cove assembly 22. For example, as shown in FIG. 21, each one of at least one or more lighting cove assemblies 22 may be snap fit into a corresponding receiver 24. Resilient brackets 24 exemplify one such receiver, and one or more a group of these brackets would provide a means to secure a corresponding lighting cove assembly 22 as it is snap fit into the resilient brackets 24. Again referring to the embodiment shown in FIG. 21, two protruding members 27 longitudinally extend along the lighting assembly frame 23 for mating with corresponding female portions 29 in brackets or attachment means 24, once lighting cove assembly 22 is snap fit into resilient receivers or brackets 24. In accordance with the present invention, each lighting cove assembly 22 could later be removed or moved to a different position on the back panel 14 to accommodate a different desired lighting scheme.

Again referring to FIG. 1, a hinged panel 50 is shown in an “unlocked” position, whereby access to the interior of the assembly is facilitated. To lock the assembly 10 in a closed position, the top panel 16 slidably moves along sliding tracks 18 and 20 to overlay the top panel 16 over the bottom panel 14. A bottom edge 52 of panel 14 is juxtaposed with panel 50 as panel 50 overlays bottom edge 52 to lock the assembly 10 in a closed position. A locking mechanism 54 attached to the display 10 schematically illustrates a key and lock system, or some other locking system, that when secured in a locked position locks the hinged panel 50 in place, thereby ensuring tamper-proof conditions of the assembly 10, and also mitigating the likelihood of theft.

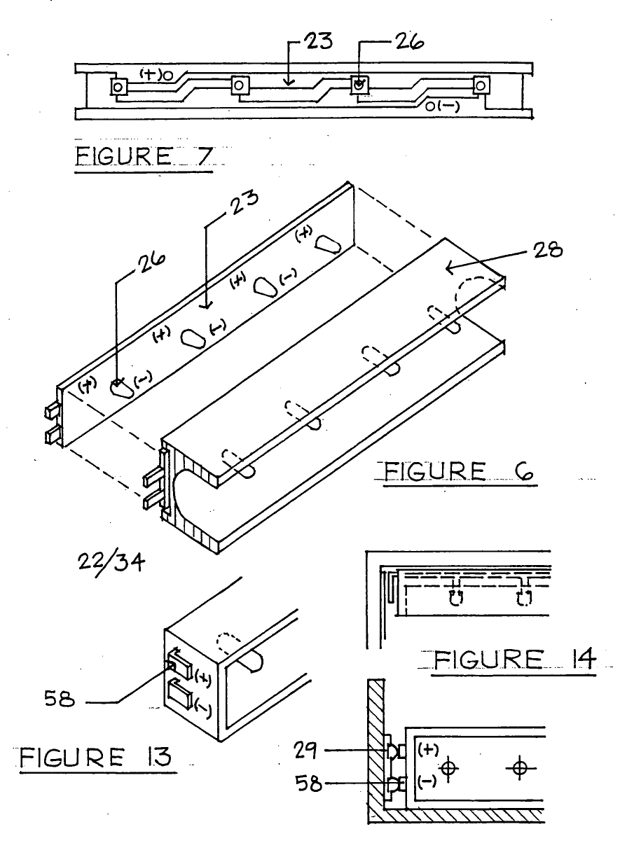

As also schematically shown in the FIGURES, FIGS. 6 and 7 for example, a plurality of LED bulbs 26 are installed in each lighting cove assembly 22, and are used to illuminate the display assembly 10. Other bulbs or lights may be employed within the lighting cove assembly 22 so long as the lights are installed beneath a respective cove 28 of each lighting cove assembly 22. Accordingly, it will be appreciated that each lighting cove assembly 22 contains at least one LED light 26 communicating with a power supply and a cove 28 for mitigating the intensity of the light(s) 26 while yet also dispersing the same light. A power supply strip 29, powered by battery or electricity, is oriented along a side edge 31 of back panel 14 and electronically communicates with each lighting cove assembly 22 for powering thereof. The power supply strip 29 may be made by EMPAT of Holly, Mich., for example. Other alternative lighting assemblies 23 are contemplated. For example, a string of LED lights could be inserted in through the exterior side 14b of the back panel 14 to extend into the interior of the assembly 10, but beneath a cove 28 already snap fit into place. Each string could be electrically connected to other strings of LED lights employed, and ultimately powered by one power source, or, each string could be independently connected to a power source such as a battery or electrical outlet (not shown). However the lighting is provided, it will be appreciated that the lighting assembly 23 will generally contain a light source such as LED bulbs 26 in communication with a power supply, and, that lighting assembly 23 will be positioned beneath the coves 28 in accordance with the present invention.

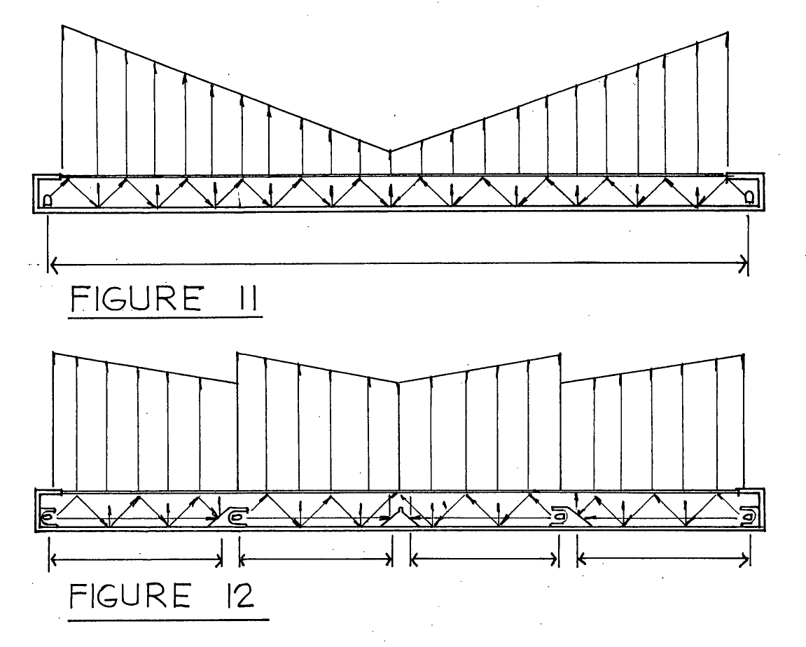

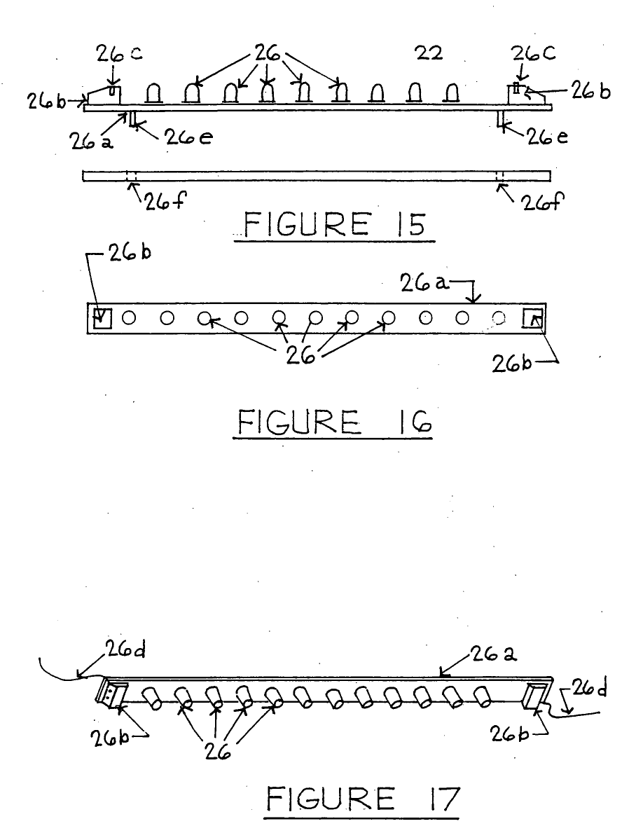

In yet another aspect of the invention, and as shown in FIGS. 15-18, LED lights 26 may be provided in a lighting strip 26a, wherein each LED light 26 is electronically connected with the other LED bulbs 26 in the strip 26a. Electronic jacks 26b are provided at both ends of each LED lighting strip 26a, wherein a wire harness (not shown) sized at 18 to 24 gauge for example and communicating with a power supply or source (not shown), is releasably fixed within each electronic jack 26b, thereby powering the lighting strip 26a. A spring loaded holder 26c is preferably contained within each electronic jack 26b, whereby the holder 26c may be opened to receive a wire 26d from a wire harness (not shown), and then released to provide a spring bias on the wire 26d for retention thereof. The wire 26d is therefore releasably fixed within electronic jack 26b when power is supplied to strip 26a, but may be quickly removed from the electronic jack 26b for adjustably positioning the strip 26a to another location on the interior side 14a of back panel 14. The LED lighting strip 26a may be made by EMPAT of Holly, Mich., for example.

In yet another aspect of the invention, and as shown in FIG. 15, one or more protruding members 26e extend from the lighting strip 26a, and may be molded therein for example. One or more, and preferably two or more, corresponding apertures or second attachment means 26f may be formed in the interior side 14a of the back panel 14, for receipt of a corresponding protruding member 26e. Accordingly, lighting strips 26a may be adjustably positioned on the interior side 14a of back panel 14 by virtue of the releasable aspect of wires 26d within holders 26c, and by the ability to quickly relocate each lighting strip 26a by fixing a respective protruding member(s) 26e within a different desired corresponding aperture(s) or attachment means 26f. It will be appreciated that protruding members 26e may also extend from cove light assemblies 22 whereby the cove assembly 22 may in the same manner be adjustably positioned on the interior side 14a of back panel 14. The lighting strip 26a shown in FIG. 15 therefore schematically represents the entire cove lighting assembly 22 in accordance with the present invention, wherein a cove 28 may simply be glued or otherwise fixed over lighting strip 26a in accordance with the present invention.

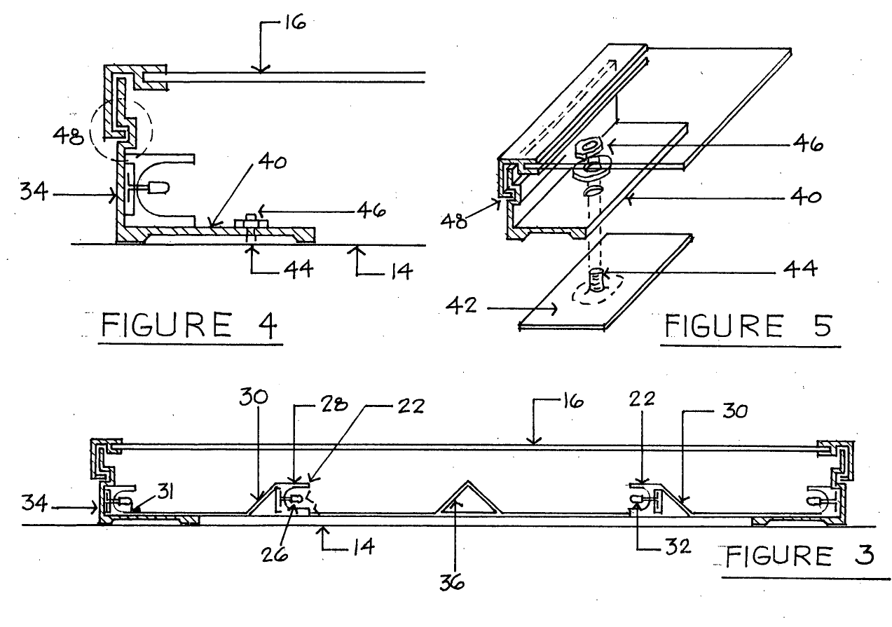

In yet another embodiment, one or more coves 28 or cove lighting assemblies 22 are positioned somewhere within a central portion 29 of the back panel 14, whereby various lighting such as LED bulbs are positioned underneath each cove 28 thereby mitigating the intensity of each LED light or other light source. The “central portion” 29 is defined to mean all positions not juxtaposed to the edges of the assembly 10, or those positions peripheral to the assembly 10. As shown in FIGS. 3 and 8, for example, a reflective portion 30 is preferably provided opposite the open end 32 of the cove 28. As also shown, this reflective portion 30 is not provided along the edge cove lighting assemblies 34. At least one reflective panel 36 may be positioned between two of the lighting cove assemblies 22 and/or 34, thereby providing additional reflective surfaces for dispersion of the light emanating from the lighting cove assemblies 22 and/or 34. As shown in FIG. 3, a reflective panel 36 is positioned between the two central-most lighting cove assemblies 22, whereby a first reflective edge 36a and a second reflective edge 36b are angled opposite to one another. As also shown in FIGS. 3 and 4, lighting cove assemblies 22 and/or 34 may include an inner reflective portion 31 that reflects light outwardly from the LED bulb beneath the cove 28.

Referring now to FIGS. 4 and 5, a mounting surface 40 the housing 12 may be mounted on any given substrate 42, such as a vehicle (schematically represented as substrate 42), by securing the mounting surface 40 to the substrate 42. In FIG. 5, a bolt 44 and a nut 46 serve to secure or fix the assembly 10 to the substrate 42. The slidable interface 48 between panels 14 and 16 illustrates the ready access to the interior of the assembly 10, whereby the advertisement may be changed, and/or the lighting may be customized to accommodate a different illumination design. When in a locked position, the locking mechanism 54, as described above, prevents access to bolt 44 and nut 46 thereby locking the display assembly 10 to the substrate 42.

FIG. 8 illustrates yet another embodiment of the present invention wherein lighting cove assemblies 22 are shown positioned in the “central portion or region” 14c of the assembly 10. FIG. 9 illustrates peripheral lighting used to illuminate the display assembly. FIG. 10 on the other hand, illustrates an illumination display assembly in accordance with the present invention. It will be appreciated that the present inventor has discovered that the relative amount of lighting and the amount of power needed in the present illumination display assemblies 10 is substantially reduced as compared to the peripheral lighting shown. FIG. 11 illustrates the dissipation of light across the central portion 29 when employing peripheral lighting as shown in FIG. 9. On the other hand, FIG. 12 illustrates the benefit of the current reflective configuration in the present assembly 10 as shown in FIG. 10. It will be appreciated that the light intensity across the central portion 29 of an assembly 10 formed in accordance with the present invention, remains relatively constant in the embodiment shown in FIG. 10.

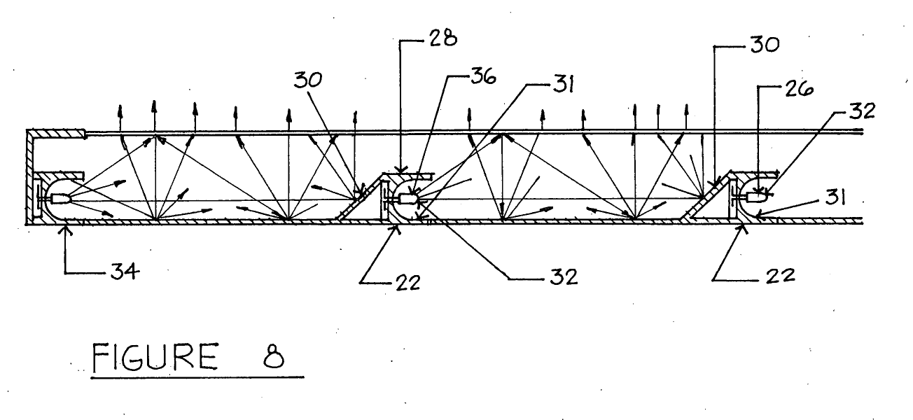

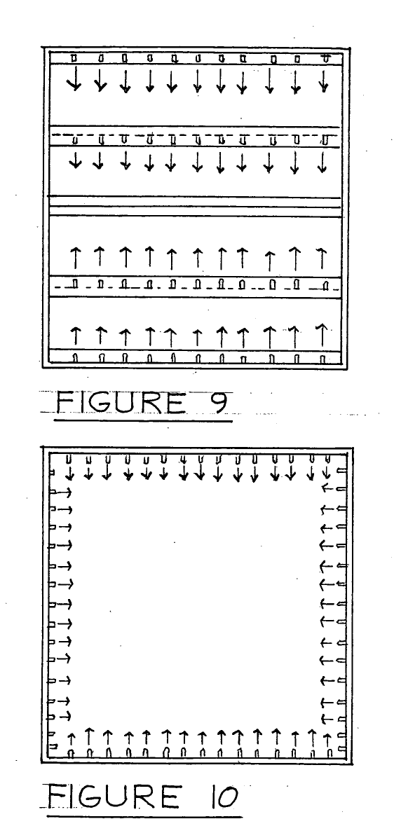

FIG. 13 illustrates contact points 58 on a cove lighting assembly 22 made in accordance with the present invention. FIG. 14 illustrates communication between the contact points 58 on the cove lighting assembly 22 and the power supply strip 29, in accordance with one embodiment of the present invention.

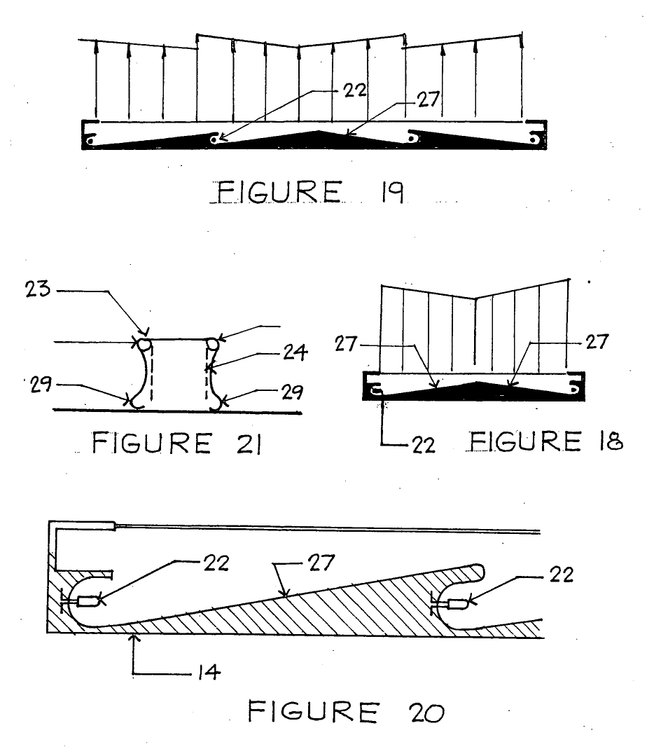

FIGS. 18-20 illustrate yet other embodiments of the present invention where the back panel 14 is designed with one or more slanted or pitched reflective portions 27 formed in the inner side 14a of the panel 14. In one embodiment, a glossy white finish is employed for the reflective surface of inner side 14a. The need to create reflective surfaces 30, 36a, and 36b is therefore obviated because these features are integrated within the slanted portions 27 in back panel 14, and the overall manufacturing complexity is reduced. Accordingly, the cove lighting assemblies 22 used in the embodiment shown in FIG. 18 do not utilize or contain reflective surfaces 30, 36a, or 36b. It will be appreciated that the light created by the LED lighting or other lighting may therefore be dispersed or reflected across the interior of the lighting assembly 10 by virtue of the pitched surface(s) 27. It will also be appreciated that when employing this type of pitched interior panel 14a, the need for a cove light assembly 22 may also be reduced or eliminated. It has been found that when employed in certain embodiments, peripheral lighting as shown in FIG. 18 results in sufficient uniform lighting across the central portion 14c when employing one or more pitched surfaces 27.

Unless otherwise indicated herein, the various constituents of the present invention are made in known manners to include injection molding, stamping, and other forming methods. For example, the back panel 14 and the front panel 16 (other than the transparent or translucent medium) may be made from metal, plastic, wood, or other suitable substrates. The lighting cove assembly frame 23 may be made from plastic, wood, metal, or other suitable substrates, and formed from known methods, injection molding for example. Brackets or bracket groups 24, also referred to as attachment means, may be made from wood, metal, plastic, or other suitable substrates. The LED lights 26 may be made in a known manner, as strings of lights for example, and then simply inserted or press-fit in cavities 25 formed within the lighting assembly frame 23. As discussed above, the lighting 26 is then connected to a power supply, for illumination thereof. Alternatively, the lighting strip 26a, for example, may be pre-assembled wherein the various lighting constituents as described above are soldered and/or glued on strip 26a.

It will be understood that the foregoing descriptions of embodiments of the present invention are for illustrative purposes only. As such, the various structural and operational features herein disclosed are susceptible to a number of modifications commensurate with the abilities of one of ordinary skill in the art, none of which departs from the scope of the present invention as defined in the appended claims.

What is claimed is:

1. An illumination display assembly comprising:
a housing comprising a back panel and a translucent or transparent front panel, said back panel having an interior side and an exterior side;
two or more attachment means fixed to or formed in said interior side of said back panel;
one or more light assemblies, wherein each light assembly is removably fixed to a corresponding one of said two or more attachment means, and, said one or more light assemblies communicate with a power source when actuated, said one or more light assemblies movable to alternate positions to modify the relative light within a given area of an interior of said illumination display assembly; and
one or more coves, wherein each cove corresponds to a respective one of said one or more light assemblies, each cove reducing the intensity of the light of said light assembly.

2. The illumination display assembly of claim 1 wherein said interior side of said back panel is reflective.

3. The illumination display of claim 1 wherein said interior side of said back panel includes at least one pitched surface for reflection of light within said illumination display.

4. The illumination display assembly of claim 1 wherein said one or more receivers are formed from at least one resilient bracket fixed to said back panel.

5. The illumination display assembly of claim 1 wherein said one or more light assemblies contain at least one light emitting diode.

6. The illumination display assembly of claim 1 wherein said one or more coves contain a reflective coating on an inner wall of each of said one or more coves.

7. The illumination display assembly of claim 1 wherein said back panel contains at least one reflective panel extending from said back panel for dispersion of light.

8. The illumination display assembly of claim 1 wherein said front panel is formed from a translucent polymeric advertisement.

9. The illumination display assembly of claim 1 further comprising a power supply strip on said back panel, wherein each of said one or more light assemblies communicates with said power supply strip.

10. An illumination display assembly comprising:
a housing comprising a back panel and an interior defined by said housing, said back panel having an interior side and an exterior side;
two or more attachment means fixed to or formed in said interior side of said back panel; and
one or more cove light assemblies, wherein each cove light assembly is adjustably positioned within said interior and within one of said two or more attachment means, and, said one or more cove light assemblies communicate with a power source when actuated.

11. The illumination display assembly of claim 10 further comprising a translucent or transparent front panel slidably communicating with said back panel.

12. The illumination display assembly of claim 11 further comprising a lock assembly contained within said housing for locking said front panel to said back panel.

13. The illumination display assembly of claim 11 further comprising at least one mounting assembly on said back panel for mounting to a substrate.

14. The illumination display assembly of claim 10 wherein said interior side of said back panel includes at least one slanted portion for reflection and dispersion of light.

15. An illumination display assembly comprising:
a housing comprising a back panel, and an interior defined by said housing, said back panel comprising an interior side and an exterior side;
peripheral lighting fixed about the periphery of said housing; and
at least one pitched reflective portion on said interior side.

16. The display assembly of claim 15 further comprising a translucent or transparent front panel, wherein said front panel slidably communicates with said back panel.

17. The display assembly of claim 15 further comprising at least one cove light assembly adjustably positioned on said back panel.

18. The display assembly of claim 16 further comprising a locking assembly to secure said display assembly to a substrate.
